(19) United States
(12) Patent Application Publication
(10) Pub. No.: US 2004/0170167 A1
(43) Pub. Date: Sep. 2, 2004

(54) System and method for performing combined tdm and packet switching a tdm cross connect

(76) Inventor: Ron Cohen, Nes Ziona (IL)

Correspondence Address: Mark Friedman, Bill Polkinghorn, Discovery Dispatch, 9003 Florin Way, Upper Marlboro, MD, 20772, US

(21) Appl. No.: 10/480,094

(22) PCT Filed: Jul. 1, 2002
(86) PCT No.: PCT/US03/03419

Related U.S. Application Data
(60) Provisional application No. 60/303,069, filed on Jul. 6, 2001.

(51) Int. Cl. H04L 12/56

(52) U.S. Cl. 370/389

(57) ABSTRACT

An architecture and method for enhancing a TDM cross-connect to perform packet switching. In particular, a method and architecture that adds to an existing TDM switch at least two packet switching line cards that perform all packet-processing tasks includind filtering, shaping and policing, forwarding and scheduling, while utilizing the TDM cross-connect existing infrastructure.

### CROSS-REFERENCE TO RELATED APPLICATIONS

This application is entitled to the benefit of priority from U.S. Provisional Application No. 60/303,069 filed 6 Jul., 2001.

### FIELD AND BACKGROUND OF THE INVENTION

Packet Switching and Time-Division-Multiplexing (TDM) circuit switching are two paradigms used in different realms of the communication world. Computer networks communicate by passing packets from sender to receiver. Intermediate network devices switch individual packets by examining attributes within each packet. The Internet is built of such packet switches called IP (Internet Protocol) routers, which base the forwarding decision on the IP address attributes within each packet. Computer communications usually assume statistical multiplexing multiple packet streams from an unbound set of senders on each communication circuit. The packet switch receives a flow of packets from each of its communication interfaces, sometimes named ports, performs a lookup operation that determines the outgoing port from which these packets need to be forwarded, and sends packets via its outgoing port. The packet switch performs some manipulation on the attributes of each packet. It may drop packets when the rate of packets that need to be sent via a port is larger than the speed of the outgoing port. The packet switch can withstand a temporary burst of packets by queuing some of the packets before being transmitted. Packet switches perform additional packet processing tasks including grooming of the packet streams to a specific rate, queuing and scheduling packets according to a specified set of rules, etc. A common architecture for a high-speed packet switch is composed of a number of line cards, a switching fabric and a central card, as shown in FIG 1.

FIG. 1 describes a general, common practice packet switch architecture 10. Packet switch 10 includes a plurality of line cards 12 (in this example 4 cards a-d) having line interfaces or ports (not shown), at least one central card 14, and at least one switching fabric 16. Each line card receives and sends packets via its line interfaces (ports). The forwarding decision is made on the line card that receives tile packet, and the packet is sent across the switching fabric to its final destination port that belongs to one (the same or a different one) of the line cards. Switching fabric 16 can be implemented in various ways, but the common practice in present high-speed packet switches is to use a fabric that carries fixed size packet fragments between ingress and egress line cards ports. Each line card fragments the packet it wants to forward, and instructs the fabric to forward tile fragment to the outgoing (“egress”) line card and port. Central card 14 is used for background tasks, including running routing protocols that determine the forwarding tables of the switch, running configuration and management tasks, etc. Some switches include more than one central cards and/or fabric for redundancy.

The predominant TDM transmission technology is SONET/SDH. SONET (Synchronous Optical Network) is a high-speed synchronous network specification developed by Bellcore and designed to run over optical fiber. SDH (Synchronous Digital Hierarchy) is the international version of the SONET standard. The differences between SONET and SDH specifications are minor. A list of SONET/SDH references and a good explanation of this TDM technology can be found in American National Standards Institute's, “Synchronous Optical Network (SONET)—Basic Description including Multiplex Structure, Rates and Formats,” ANSI T1.105-1995; in ITU Recommendation G.707, “Network Node Interface For The Synchronous Digital Hierarchy”, 1996; and in Telcordia Technologies, “Synchronous Optical Network (SONET) Transport Systems: Common Generic Criteria”, GR-253-CORE, Issue 3, Nov. 2000.

A SONET/SDH signal is composed of multiple multiplexed circuits carrying telephony, video and data. SONET/SDH is a byte-multiplexing technology. For example, the stream of bytes of a SONET/SDH signal carrying three multiplexed circuits is composed of a repetitious series of byte triplets, each byte belonging to a different circuit. A circuit is established between two edge nodes, e.g. between two central telephony offices. The circuit is multiplexed into the TDM SONET/SDH hierarchy and is transported across multiple TDM switches until is reaches its final destination. The TDM switches interconnect TDM circuits arriving from different incoming interfaces to circuits in outgoing interfaces. The TDM switching fabric (also called switching matrix), which determines the mapping between incoming and outgoing circuits, is configured out-of-band and is not based on attributes carried in the TDM signal itself.

In operation, the line cards receive TDM signals, align the TDM signal such that the fabric will be able to recognize the beginning of the TDM multiplex (e.g. align the triplet of bytes of three multiplexed circuits such that the TDM signal starts at the first byte of the triplet), and pass the stream to the fabric. The switching matrix switches the incoming bytes between its ports. For example, the switching matrix may switch the first of each incoming triplet of bytes towards one line card, and the two other bytes in each triplet towards a different line card. The stream of bytes sent to a given line card is sent via the line card's outgoing port. The switch fabric matrix is controlled and configured by the central card. The switching usually remains static, and changes in the circuit-switching configuration are rare. Circuits are not statistically multiplexed.

The success of computer communications led to an increase in demand for data packet forwarding, while the demand for TDM transmission and switching does not increase at the same rate. This led TDM vendors to try and find away to include packet switching solutions within their TDM based equipment. Comparison of TDM and packet switches reveals technologies that are quite different. The challenge is how to enhance a TDM switch with added packet switching functionality, without redesigning the whole system. The required solution should not modify the existing components of the TDM switch, and enable a mixture of the existing TDM line cards with new cards that provide packet switching functionality. The most obvious solution is adding a parallel packet switching system with its own packet switching fabric. This is not an acceptable solution, as the price and complexity of adding the new switching fabric and maintaining dual switching fabrics makes it unfeasible. The heart of the TDM switch is its switching fabric and the way it is connected to the line cards. Any solution must reuse this switching infrastructure.

There is thus a widely recognized need for, and it would be highly advantageous to have, a system and method for performing combined TDM and packet switching that uses the existing TDM switching infrastructure without changing its existing components.

### SUMMARY OF THE INVENTION

According to the present invention there is provided a system for performing combined TDM and packet switching, comprising a modified TDM cross connect switch that includes a TDM switching matrix configured to perform TDM tasks, and at least two packet switching line cards incorporated in the modified TDM switch and connected to the TDM switching matrix, whereby the incorporation of the at least two packet switching line cards in the modified TDM switch provides the system with combined TDM and packet switching capabilities.

According to the present invention there is provided in a first embodiment a method for performing packet switching in a TDM cross connect switch, comprising providing a modified TDM switch that includes a TDM switching matrix and a plurality of packet switching line cards, each of the packet switching line cards having a first plurality of ports, each port having a respective rate, configuring a plurality of TDM circuits across the TDM switching matrix between each pair of packet switching line cards, and using the circuits to switch packets through the TDM cross connect switch.

According to one feature in the first embodiment of the method of the present invention, the step of using the circuits to switch packets through the modified TDM cross connect switch includes receiving at least one packet on one packet switching line card, deciding to send the at least one packet on one of the plurality of TDM circuits to a second packet switching line card, and extracting the at least one packet from the second packet switching line card.

According to the present invention there is provided in a second embodiment a method for emulating TDM transmission over a packet network, comprising providing a modified TDM switch that includes a TDM switch matrix, at least one TDM line card, and at least one packet switching line card having a plurality of ports, and packetizing and de-packetizing the TDM signal transmitted over the packet network at the packet line card, using the modified TDM switch, and

According to one feature in the second embodiment of the method of the present invention, further comprises configuring a plurality of TDM circuits over the TDM switch matrix to provide configured TDM matrix circuits.

According to another feature in the second embodiment of the method of the present invention, the step of packetizing and de-packetizing the TDM signal includes setting up at least one TDM circuit between the at least one TDM line card and one of the at least one packet switching line cards, packetizing the TDM signal in one of the at least one packet switching line cards, transmitting the packetized TDM signal through the packet line card ports, de-packetizing the TDM signal in one of the at least one packet switching line cards, and placing the TDM signal on the configured TDM matrix circuits.

### BRIEF DESCRIPTION OF THE DRAWINGS

The invention is herein described, by way of example only, with reference to the accompanying drawings, wherein:

FIG. 1 describes a general common use packet switch architecture;

FIG. 2 describes three packet switches interconnected via a TDM cross connect switch;

FIG. 3 describes an architecture of a modified TDM cross connect enhanced to perform packet switching;

FIG. 4 is a block diagram illustrating the steps of a method that uses of the architecture of FIG. 3;

FIG. 5 is a block diagram illustrating the use of a modified TDM cross connect for circuit emulation;

### DESCRIPTION OF THE PREFERRED EMBODIMENTS

The present invention is of architecture of enhancing a TDM cross connect switch to perform packet switching, and of methods for using this architecture for combined TDM and packet switching tasks. The architectural solution is to preferably add a plurality of “packet switching line cards” that can do packet switching decisions to a TDM cross connect, and to use the existing TDM switching matrix to provide connecting circuits between these packet switching cards. The TDM matrix is configured in advance with circuits between each pair of packet switching line cards. An ingress packet line card makes the forwarding decisions and, according to the forwarding lookup result, sends each packet via a circuit destined to a different packet line card. An egress packet line card extract packets out of the TDM switching fabric circuit, an forwards them as packets via one of its packet interfaces. The best way to understand this solution is to view it as integrating external packet switches as “packet line cards”, and as unifying the central cards of the external packet switches to a single central card that acts as a common controller.

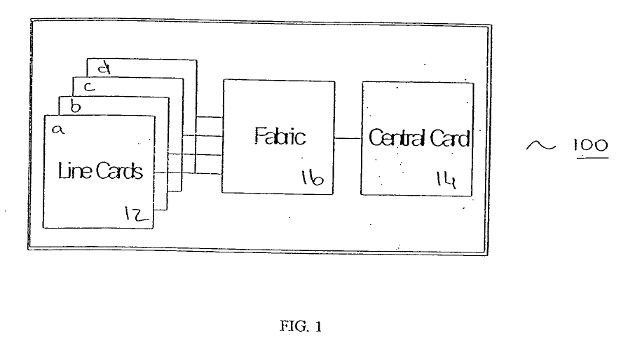

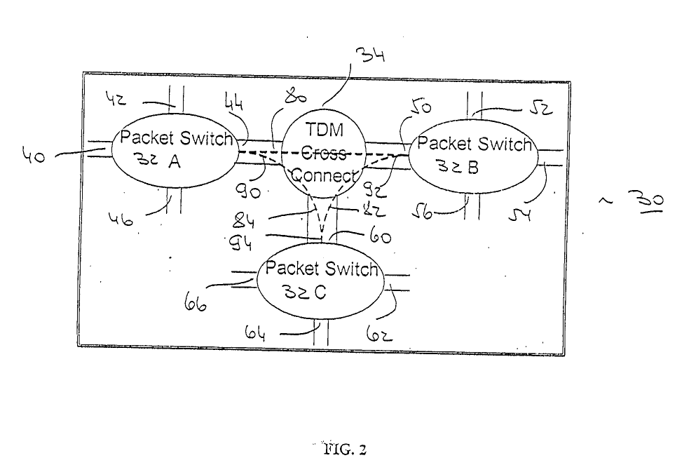

FIG. 2 describes a network 30 that includes three packet switches 32(a, b, c), each similar to the one described in FIG. 1, interconnected via a TDM cross connect switch 34. Each of the 3 packet-switches has four interfaces or “ports”. Packet switch 32a has four ports 40, 42, 44 and 16, packet switch 32b has four ports 50, 52, 54 and 56, and packet switch 32c has four ports 60, 62, 64, and 66. Each switch switches packets between its four ports. For example, switch 32a switches packets between its ports 40, 42, 44 and 46. Each of the packet switches described in this figure is built using the architecture described in FIG. 1, i.e. each includes in general a plurality of line cards, at least one central card and at least one fabric plus, optionally, additional elements and functionalities that are not shown. The four ports within each packet switch may reside on different line cards of that switch. Multiplexed TDM signals are running respectively between each of packet switches 32a 32b and 32c and TDM switch 34.

A TDM circuit is configured between each of the three packet-switches: a circuit 80 between a and b, a circuit 82 between b and c and a circuit 34 between c and a. TDM cross connect switch 34 (“TDM switch 34” for short) extracts circuits 80 and 84 from a multiplexed TDM signal 90 running between packet switch 32a and TDM cross connect switch 34, and switches the two circuits towards multiplexed TDM signals 92 and 94 running between TDM switch 34 and packet switches 32b and 32c correspondingly. Similarly, TDM switch 34 extracts circuits 80 and 82 from a multiplexed TDM signal 92 running between packet switch 32b and TDM switch 34, and switches the two circuits towards multiplexed TDM signals 94 and 90 running between TDM switch 34 and packet switches 32a and 32c correspondingly. Similarly, TDM switch 34 extracts circuits 32 and 34 from a multiplexed TDM signal 94 running between packet switch 32c and TDM switch 34, and switches the two circuits towards multiplexed TDM signals 90 and 92 running between cross-connect switch 34 and packet switches 32a and 32b correspondingly. TDM switch 34 has multiple other TDM ports not shown in this figure.

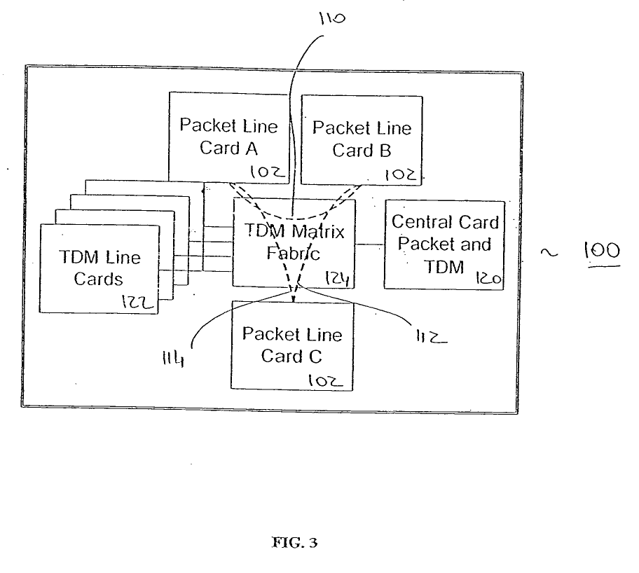

FIG. 3 describes an architecture of a “modified” TDM switch 100 enhanced to perform packet switching. The three packet switches of FIG. 2 are integrated into the mollified TDM switch as packet switching line cards 102a, b and c, which correspond respectively to packet switches 32a, b, and c in FIG. 2. Note that three packet line cards are used as an example only, and that a modified TDM switch according to the present invention may include any member of two or more such elements. Circuits are configured between each of the packet line cards across a TDM matrix fabric 124 which is a standard and unchanged TDM fabric. Thus, a circuit 110 is configured between cards 102a and b, a circuit 112 is configured between cards 102b and c, and a circuit 114 is configured between cards 102c and a. All routing, signaling and management tasks are run on a single central card that may or may not be collocated with a TDM central card. In FIG. 3, a central TDM and packet card 120 is used as a central card for both TDM and packet tasks, and in particular unifies the central tasks of the three packet switches (packet line cards 102a, b and c) and provides an appearance of a single switch to external management and control entities. Switch 100 includes in addition a plurality of TDM line cards 122 which are also unchanged from the standard TDM architecture.

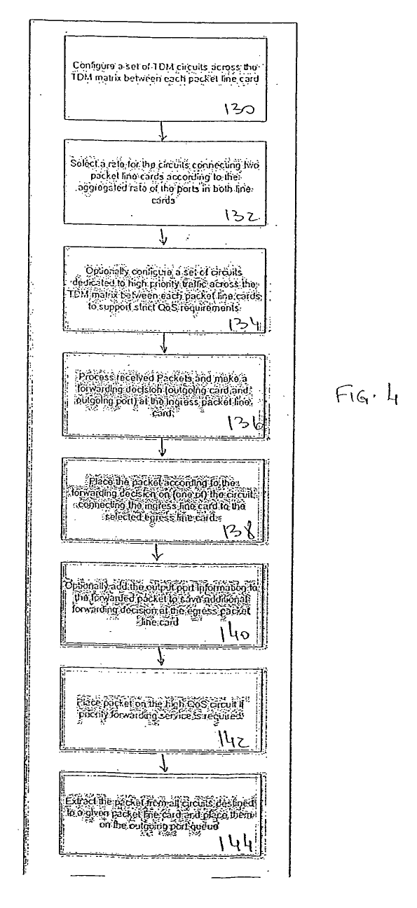

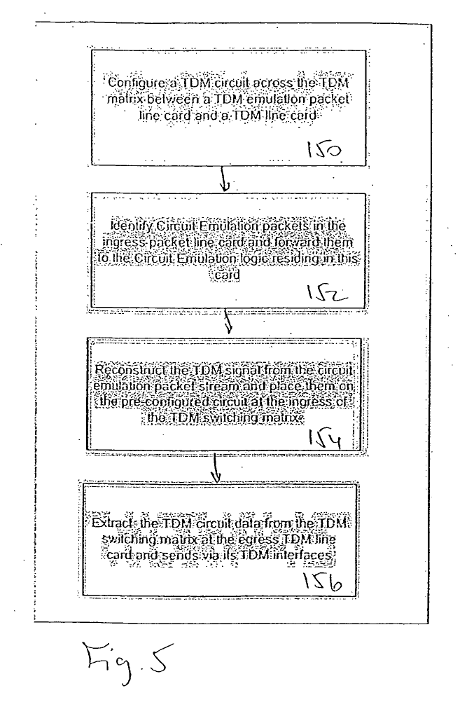

A major advantage of architecture 100 described above, is that there is no need to redesign the standard TDM switch components, e.g. line cards, switching matrix, etc, in order to provide the added packet switching functionality. This added functionality, which includes packet-to-packet applications (FIG. 4) and circuit-emulation —TDM applications (FIG. 5) is obtained by adding “packet line cards”. The new functionality is typically provided entirely within the packet line cards, and in some cases within the central card.

FIG. 4 presents and exemplary flow chart of a method of using architecture 100 to perform packet switching within a TDM cross connect system, without modification/upgrades to the TDM matrix fabric or the TDM line cards operation. After the system is turned on, central TDM and packet card 120 configures a set of circuits across the TDM switching fabric that interconnects all packet line cards in a configuration step 130. The rate of the circuits connecting each pair of packet line cards is dependent on the aggregated rate of all ports within each of the packet line cards. That is, in order to make sure that TDM switching fabric 124 can forward all packets between the packet line cards, the rate of the circuits connecting the two packet line cards should be no smaller than the aggregated rate of all ports in either one of the packet line cards. For example, assume that circuits across TDM fabric 124 connect a pair of line cards, say card A and card B. If the aggregated rate of all ports of card A is X, and the aggregated rate of all ports of card B is Y, then the circuit rate connecting them should be larger than MIN(X,Y). This rate is selected in a rate selection step 132. If there is a need to support assurance in the Quality of Service (QoS), e.g. fast forwarding without delay, special circuits can be optionally configured between packet line cards in a QoS configuration step 134. This way, bursts of regular traffic will not cause delay or drop of higher priority traffic, as each class of traffic would flow on a separate circuit. Next, a packet received on one (ingress) of the packet line cards is processed and forwarded in a forwarding decision step 136. The forwarding decision includes the egress port and outgoing (egress) packet line card. According to the forwarding decision, the packet is placed in an output information adding step 140 on a circuit connecting the ingress packet line card to the egress packet line card in a placing step 138. Preferably, the egress (output) port information may be optionally added to the forwarded packet to save the need for an additional forwarding decision at the egress packet line card. If a high priority circuit is set up between the packet line cards, the forwarding decision should determine in a circuit choosing step 142 if the packet is sent via the high QoS priority circuit, or via the regular one. At the egress packet line card, the packet is extracted from the circuit in an extraction step 144 and placed on the outgoing port queue for forwarding.

In addition, the system of the present invention enables the introduction of a new technology we call “circuit emulation”, in which TDM signals are carried over a packet network. This is the “circuit emulation—TDM” application mentioned above. Basically, the TDM signal is fragmented and placed in packets at one edge of a packet network (not shown) by an ingress packetizer apparatus, and sent towards another, remote edge of the packet network (not shown), where the TDM signal is extracted from the packet stream and placed back on a TDM circuit by an egress packetizer apparatus, as if the two TDM circuits were directly connected. The egress packetizer operation may be called de-packetization. A typical sequence of steps that show how packet switching line cards perform circuit emulation packetization operation of TDM signals is shown in FIG. 5.

FIG. 5 describes the steps of a method that uses architecture 100 is to support this new application for circuit emulation. A TDM circuit needs to be configured between a TDM line card and a packet line card in a circuit setting step 150. When a packet carrying TDM signals is received at an ingress packet line cards it is forwarded to a packetizer that extracts the TDM signal and places the extracted TDM signal on the TDM circuit at the TDM matrix fabric in a de-packetizing step 152. The TDM matrix fabric switches the TDM circuit to the egress TDM line card in a switching step 154. The egress TDM line card extracts the data from the TDM switching matrix and sends it via its TDM ports in a sending step 156. The TDM switching fabric ports and functionality remain unchanged. Only packet line cards that perform this new functionality (packet switching and TDM packetization) need to be upgraded.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

1. A system for performing combined TDM and packet switching comprising:
a. a modlified TDM cross connect switch that includes a TDM switching matrix configured lo perform TDM tasks, and
b. at least two packet switching line cards incorporated in said modified TDM switch and connected to said TDM switching matrix, whereby said incorporation of said at least two packet switching line cards in said modified TDM switch provides the system with combined TDM and packet switching capabilities.

2. The system of claim 1, wherein said connection of said at least two packet switching line cards to said TDM switching matrix includes at least one TDM circuit configured between each two of said at least two packet switching line cards across said TDM switching matrix.

3. A method for performing packet switching in a TDM cross connect switch, comprising:
i. providing a modified TDM switch that includes a TDM switching matrix and a plurality of packet switching line cards, each of said packet switching line cards having a first plurality of ports, each said port having a respective rate,
ii. configuring a plurality of TDM circuits across said TDM switching matrix between each pair of said plurality of packet switching line cards, and
iii. using said circuits to switch packets through the TDM cross connect switch

4. The method of claim 3, wherein said step of using said circuits to switch packets through the modified TDM cross connect switch includes:
i. receiving at least one packet on a first of said packet switching line cards,
ii. deciding to send said at least one packet on one of said plurality of TDM circuits to a second of said packet switching line cards, and
iii. extracting said at least one packet from said second packet switching line card.

5. The method of claim 4, wherein said substep of deciding includes selecting a rate for said plurality of TDM circuits that is no smaller than the aggregated rate of all ports in each of said first and said second packet line cards.

6. A method for emulating the transmission of a TDM signal over a packet network, comprising
a. providing a modified TDM switcb that includes a TDM switch matrix, at least one TDM line card, and at least one packet switching line card having a plurality of ports, and
b. packetizing and de-packetizing the TDM signal transmitted over the packet network using said modified TDM switch.

7. The method of claim 6, further comprising configuring a plurality of TDM circuits over said TDM switch matrix to provide configured TDM matrix circuits.

8. The method of claim 7, wherein said step of packetizing and de-packetizing the TDM signal includes:
i. setting up at least one TDM circuit between said at least one TDM line card and said at least one packet switching line card,
ii. packetizing the TDM signal in one of said at least one packet switching line cards,
iii. transmitting said packetized TDM signal through said packet line card ports,
iv. de-packetizing the TDM signal in one of said at least one packet switching line cards, and
v. placing the TDM signal on said configured TDM matrix circuits.
